(19) United States
(12) Patent Application Publication
(10) Pub. No.: US 2026/0319064 A1
(43) Pub. Date: Oct. 15, 2026

(54) JOINT SENSING AND COMMUNICATION SIGNAL CONFIGURATIONS FOR FREQUENCY-MODULATED CONTINUOUS WAVE TRANSMISSION

(71) Applicant: QUALCOMM Incorporated, San Diego, CA (US)

(72) Inventors: Min HUANG, Beijing (CN); Kangqi LIU, San Diego, CA (US); Hao XU, Beijing (CN)

(21) Appl. No.: 19/485,258

(22) PCT Filed: Aug. 2, 2023
(86) PCT No.: PCT/CN2023/110681

§ 371 Date: Nov. 17, 2025

(51) Int. Cl. G01S 7/00; G01S 13/58

(52) U.S. Cl. CPC G01S 7/006; G01S 13/584

(57) ABSTRACT

A user equipment (UE) may receive a transmission grant message. The transmission grant message may include a frequency-modulated continuous wave (FMCW) sensing and communication configuration. The FMCW sensing and communication configuration may include a first indicator of a set of FMCW sensing offsets and a second indicator of a set of FMCW communication offsets. The UE may receive a reflection of a set of FMCW sensing signals off of a target object. The UE may measure the received reflection of the set of FMCW sensing signals based on the first indicator. The UE may calculate a location of the target object based on the measured received reflection. The UE may output a third indicator of the calculated location of the target object, for example by transmitting the third indicator or by storing the third indicator on a memory of the UE.

### TECHNICAL FIELD

The present disclosure relates generally to communication systems, and more particularly, to a wireless sensing and communications system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a wireless device, such as a user equipment (UE) or a transmission reception point (TRP). The apparatus may receive a transmission grant message. The transmission grant message may include a frequency-modulated continuous wave (FMCW) sensing and communication configuration. The FMCW sensing and communication configuration may include a first indicator of a set of FMCW sensing offsets and a second indicator of a set of FMCW communication offsets. The apparatus may receive a reflection of a set of FMCW sensing signals off of a target object. The apparatus may measure the received reflection of the set of FMCW sensing signals based on the first indicator. The apparatus may calculate a location of the target object based on the measured received reflection. The apparatus may receive a set of FMCW communication signals. The apparatus may process the set of FMCW communication signals based on the second indicator. The apparatus may output a third indicator of the calculated location of the target object, for example by transmitting the third indicator or by storing the third indicator on a memory of the apparatus.

In an aspect of the disclosure, a method, a computer-readable medium, and an apparatus are provided. The apparatus may include a network node. The apparatus may transmit a transmission grant message. The transmission grant message may include an FMCW sensing and communication configuration. The FMCW sensing and communication configuration may include a first indicator of a set of FMCW sensing offsets, and a second indicator of a set of FMCW communication offsets. The apparatus may transmit a set of FMCW sensing signals based on a chirp length and the set of FMCW sensing offsets. The apparatus may transmit a set of FMCW communication signals based on the set of FMCW communication offsets. The apparatus may receive a third indicator of a location of a target object based on the set of FMCW sensing signals.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of sensing based on measurements of reflections of sensing signals.

FIG. 5A is a diagram illustrating an example of a frequency-modulated continuous wave (FMCW) chirp.

FIG. 5B is a diagram illustrating an example of sensing based on a sensing signal based on FMCW chirps.

FIG. 6 is a plurality of diagrams illustrating an example of FMCW-based sensing signals having difference cyclic shifts.

FIG. 7A is a diagram illustrating an example of another FMCW chirp.

FIG. 7B is a diagram illustrating an example of a set of FMCW chirps transmitted simultaneously based on the same bandwidth and the same duration with different shift offsets.

FIG. 8 is a diagram illustrating an example of a wireless device receiving both a sensing signal and a communication signal originating from the same wireless device.

FIG. 9 is a communication flow diagram illustrating an example of a wireless device receiving both a sensing signal and a communication signal originating from the same wireless device.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a diagram illustrating an example of a hardware implementation for an example network entity.

FIG. 14 is a diagram illustrating an example of a hardware implementation for an example network entity.

### DETAILED DESCRIPTION

The following description is directed to examples for the purposes of describing innovative aspects of this disclosure. However, a person having ordinary skill in the art may recognize that the teachings herein may be applied in a multitude of ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples may be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also may be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to wireless sensing and communication systems. Some aspects more specifically relate to devices that perform both wireless sensing and wireless communication simultaneously based on the same bandwidth and the same duration. In some examples, a wireless device may receive a transmission grant message. The wireless device may include a user equipment (UE), a base station, or a transmission reception point (TRP). The transmission grant message may include a frequency-modulated continuous wave (FMCW) sensing and communication configuration. The FMCW sensing and communication configuration may include a first indicator of a set of FMCW sensing offsets and a second indicator of a set of FMCW communication offsets. The wireless device may receive a reflection of a set of FMCW sensing signals off of a target object. The wireless device may measure the received reflection of the set of FMCW sensing signals based on the first indicator. The wireless device may calculate a location of the target object based on the measured received reflection. The wireless device may output a third indicator of the calculated location of the target object, for example by transmitting the third indicator or by storing the third indicator on a memory of the UE.

In some examples, a network node may transmit a transmission grant message. The transmission grant message may include an FMCW sensing and communication configuration. The FMCW sensing and communication configuration may include a first indicator of a set of FMCW sensing offsets, and a second indicator of a set of FMCW communication offsets. The network node may transmit a set of FMCW sensing signals based on a chirp length and the set of FMCW sensing offsets. The network node may transmit a set of FMCW communication signals based on the set of FMCW communication offsets. The network node may receive a third indicator of a location of a target object based on the set of FMCW sensing signals.

Since a long FMCW chirp utilized for sensing but not communication may lead to a low radio resource utilization ratio, utilizing the same FMCW chirp for both sensing and communication may be beneficial to improve the radio resource utilization ratio. A sensing transmitter and a sensing receiver may utilize a FMCW-based ISAC waveform for joint sensing and communication. In some aspects, the sensing transmitter and the sensing receiver may utilize CSI report operations to determine the sensing/communication parameters of such a waveform. In some aspects, a network node (e.g., a next generation node B (gNB)) may simultaneously transmit a sensing signal and a communication signal based on FMCW chirps with the same bandwidth and duration. The sensing signal and the communication signal may have different shift offsets. The network node may configure a wireless device, such as a UE or another network node (e.g., a base station, a TRP), to report joint CSI on the sensing-related parameters and communication-related parameters of FMCW chirps. In some aspects, a network node may configure the wireless device with an FMCW-based CSI-RS configuration and an FMCW-based integrated sensing and communication (ISAC) CSI report configuration. The network node may transmit FMCW-based CSI-RS in the communication link to the wireless device. The wireless device may measure the FMCW-based CSI-RS to determine the FMCW chirp parameters and may respond with an FMCW-based joint CSI report for ISAC. The network node may transmit an FMCW-based ISAC transmission grant indicating the chirp length and shift offsets for sensing and communication. The network node may determine the FMCW transmission format based on wireless device's report. The network node may transmit ISAC-based FMCW signals for both sensing and communication. In some aspects, either the network node or the wireless device may configure the sampling rate (and therefore the chirp length).

Particular aspects of the subject matter described in this disclosure can be implemented to realize one or more of the following potential advantages. In some examples, by transmitting and receiving both sensing and communication signals during the same time period and using the same bandwidth based on using different offsets for the sensing signals and for the communication signals, relative to one another, the described techniques can be used to improve radio resource utilization ratios. The same FMCW chirp may be used for both wireless sensing and wireless communication. In some aspects, the wireless device and the network node may be configured to utilize channel state information (CSI) report operations to optimize and select parameters for the sensing signal and/or the communication signal for the FMCW waveform. Such systems may improve radio resource utilization efficiency and spectrum efficiency. Such systems may enable a low-end UE to receive both sensing and communication signals. Such systems may lower the power consumption for medium-end and/or high-end wireless devices to receive both sensing and communication signals.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals may include a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

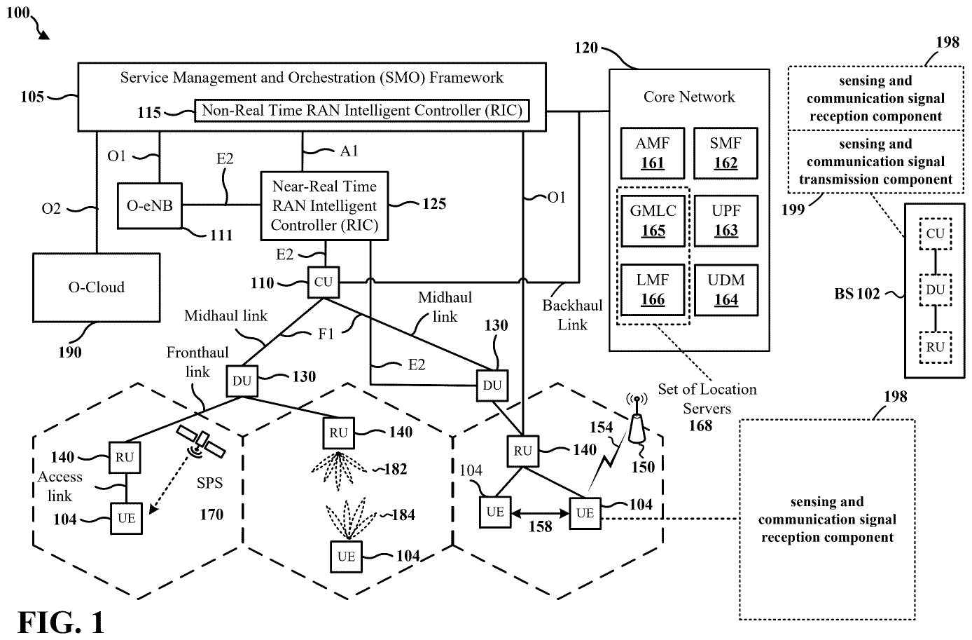

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as appropriate, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the base station 102 and/or the UE 104 may have a sensing and communication signal reception component 198 that may be configured to receive a transmission grant message. The transmission grant message may include an FMCW sensing and communication configuration. The FMCW sensing and communication configuration may include a first indicator of a set of FMCW sensing offsets and a second indicator of a set of FMCW communication offsets. The sensing and communication signal reception component 198 may be configured to receive a reflection of a set of FMCW sensing signals off of a target object. The sensing and communication signal reception component 198 may be configured to measure the received reflection of the set of FMCW sensing signals based on the first indicator. The sensing and communication signal reception component 198 may be configured to calculate a location of the target object based on the measured received reflection. The sensing and communication signal reception component 198 may be configured to receive a set of FMCW communication signals. The sensing and communication signal reception component 198 may be configured to process the set of FMCW communication signals based on the second indicator. The sensing and communication signal reception component 198 may be configured to output a third indicator of the calculated location of the target object, for example by transmitting the third indicator or by storing the third indicator on a memory of the UE 104. In certain aspects, the base station 102 may have a sensing and communication signal transmission component 199 that may be configured to transmit a transmission grant message. The transmission grant message may include an FMCW sensing and communication configuration. The FMCW sensing and communication configuration may include a first indicator of a set of FMCW sensing offsets, and a second indicator of a set of FMCW communication offsets. The sensing and communication signal transmission component 199 may be configured to transmit a set of FMCW sensing signals based on a chirp length and the set of FMCW sensing offsets. The sensing and communication signal transmission component 199 may be configured to transmit a set of FMCW communication signals based on the set of FMCW communication offsets. The sensing and communication signal transmission component 199 may be configured to receive a third indicator of a location of a target object based on the set of FMCW sensing signals. In other words, the sensing and communication signal transmission component 199 may configure a set of FMCW sensing signals and a set of FMCW communication signals to be transmitted using the same bandwidth and during the same duration with a set of FMCW sensing offsets corresponding with the set of FMCW sensing signals and a set of FMCW communication offsets corresponding with the set of FMCW communication signals. The sensing and communication signal transmission component 199 may transmit the configuration to the sensing and communication signal reception component 198 that receives the FMCW sensing and communication signals. The network node may then transmit the FMCW sensing and communication signals. On the other hand, the sensing and communication signal reception component 198 may receive the communication and may measure the sensing signals and process the communication signals based on the offsets received from the sensing and communication signal transmission component 199.

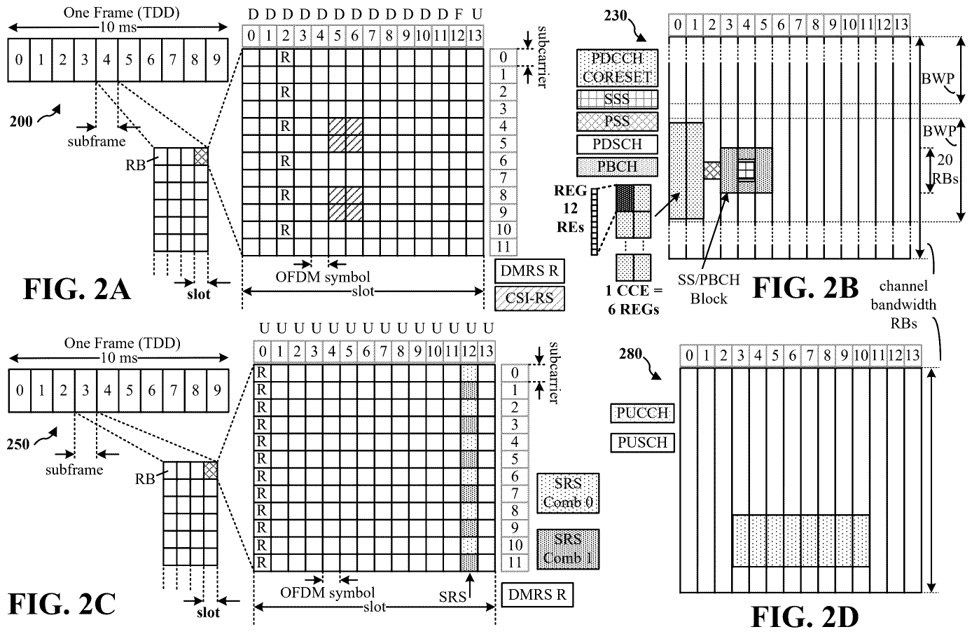

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

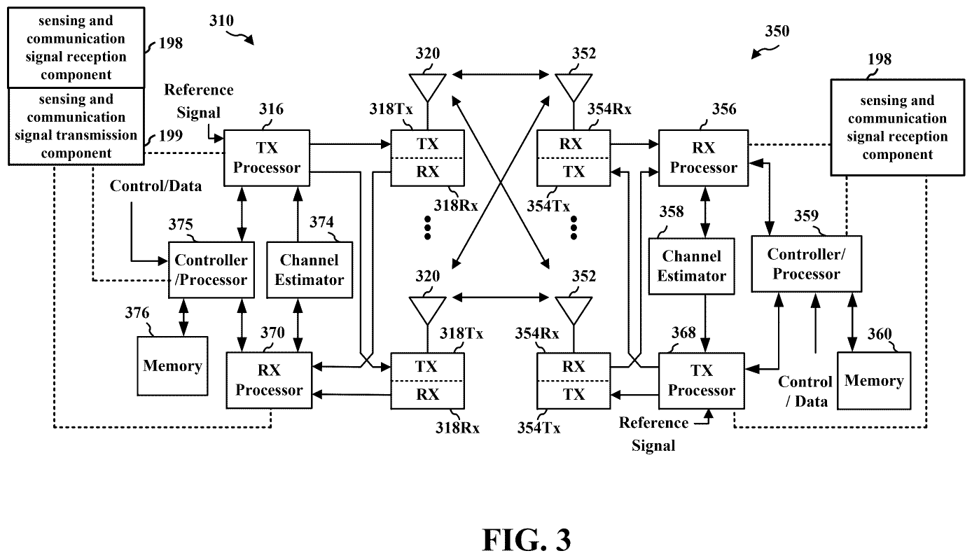

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the sensing and communication signal reception component 198 of FIG. 1.

At least one of the TX processor 316, the RX processor 370, and the controller/processor 375 may be configured to perform aspects in connection with the sensing and communication signal reception component 198 of FIG. 1.

At least one of the TX processor 316, the RX processor 370, and the controller/processor 375 may be configured to perform aspects in connection with the sensing and communication signal transmission component 199 of FIG. 1.

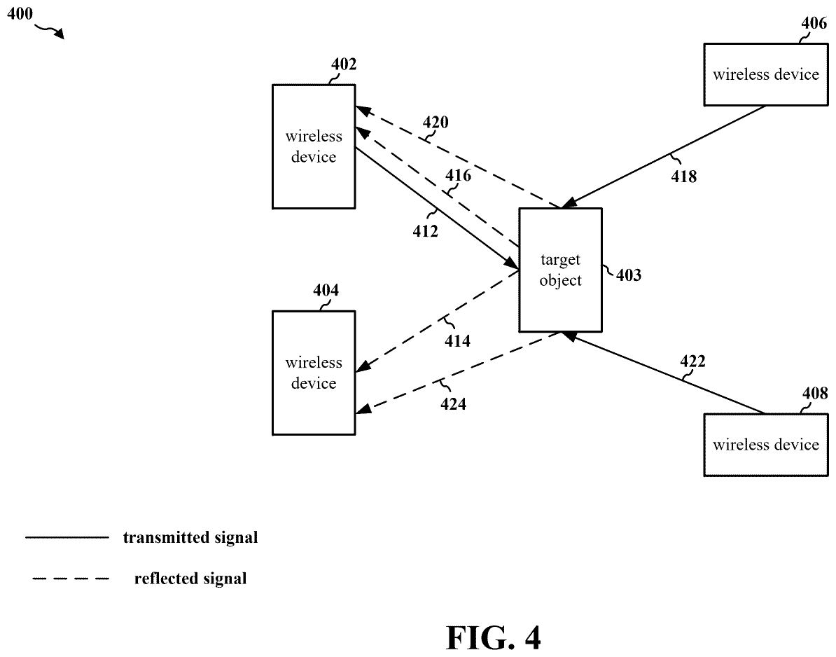

FIG. 4 is a diagram 400 illustrating an example of sensing based on measuring sensing signals transmitted by one or more sensing signals that reflect off of a target object 403. A wireless device that transmits a sensing signal that reflects off of a target object may be referred to as a transmitter node. A wireless device that receives a reflected sensing signal and measures the reflected sensing signal to perform sensing may be referred to as a receiver node. In one aspect, the wireless device 402 may perform monostatic sensing. The wireless device 402 may act as both a transmitter node and a receiver node. The wireless device 402 may transmit a set of sensing signals 412 at the target object 403, the target object 403 may reflect the set of sensing signals 412 as the reflected set of sensing signals 416 at the wireless device 402, and the wireless device 402 may measure the reflected set of sensing signals 416 from the target object 403. In another aspect, the wireless device 402 and the wireless device 404 may perform bistatic sensing. The wireless device 402 may act as a transmitter node and the wireless device 404 acts as a receiver node. The wireless device 402 may transmit a set of sensing signals 412 at the target object 403, the target object 403 may reflect the set of sensing signals 412 as the reflected set of sensing signals 414 at the wireless device 404, and the wireless device 404 may measure the reflected set of sensing signals 414 from the target object 403. In another aspect the wireless device 402 and the wireless device 406 may perform multi-static sensing. The wireless device 402 may act as both a transmitter node and a receiver node, for a first set of sensing signals, and the wireless device 406 acts as a transmitter node while the wireless device 402 acts as a receiver node for a second set of sensing signals. In addition to the wireless device 402 measuring the reflected set of sensing signals 416 from the target object 403 using monostatic sensing, the wireless device 406 may transmit a set of sensing signals 418 at the target object 403, the target object 403 may reflect the set of sensing signals 418 as the reflected set of sensing signals 420 at the wireless device 402, and the wireless device 402 may measure the reflected set of sensing signals 420 from the target object 403. In another aspect the wireless device 402, the wireless device 404, and the wireless device 408 may perform multi-static sensing. The wireless device 402 may act as a transmitter node and the wireless device 404 acts as a receiver node for a first set of sensing signals, and the wireless device 408 acts as a transmitter node and the wireless device 404 acts as a receiver node for a second set of sensing signals. In addition to the wireless device 404 measuring the reflected set of sensing signals 414 from the target object 403 using bistatic sensing, the wireless device 408 may transmit a set of sensing signals 422 at the target object 403, the target object 403 may reflect the set of sensing signals 422 as the reflected set of sensing signals 424 at the wireless device 404, and the wireless device 404 may measure the reflected set of sensing signals 424 from the target object 403. Each wireless device may be any wireless device configured to transmit or receive wireless signals, such as UEs, network nodes, TRPs, or base stations. For example, the wireless device 402 may be a network node configured to transmit the set of sensing signals 412 at the target object 403 and measure the reflected set of sensing signals 416 from the target object 403. In another example, the wireless device 402 may be a network node configured to transmit the set of sensing signals 412 at the target object 403, and the wireless device 404 may be a UE configured to measure the reflected set of sensing signals 414 from the target object 403.

The wireless device 402 may conduct one or more sensing measurements on the reflected set of sensing signals 416 and/or the reflected set of sensing signals 420. In one aspect, the wireless device 402 may calculate a distance or a range between the wireless device 402 and the target object 403 based on a round trip time (RTT) between when the wireless device 402 transmits the set of sensing signals 412 and when the wireless device 402 receives the reflected set of sensing signals 416. In one aspect, the wireless device 402 may calculate a distance or a range that the set of sensing signals 418 and the reflected set of sensing signals 420 travels based on a time between when the wireless device 406 transmits the set of sensing signals 418 and when the wireless device 402 receives the reflected set of sensing signals 420. In one aspect, the wireless device 402 may calculate a location of the target object 403 based on a plurality or range or distance measurements, for example via triangulation using known positions of the wireless devices 402 and 406 and the calculated range or distance measurements. In one aspect, the wireless device 402 may calculate a velocity of the target object 403 based on a first calculated location of the target object 403 based on the reflected set of sensing signals 416 and/or the reflected set of sensing signals 420 measured at a first time, and a second calculated location of the target object 403 based on the reflected set of sensing signals 416 and/or the reflected set of sensing signals 420 measured at a second time. In one aspect, the wireless device 402 may calculate an AoA of the reflected set of sensing signals 416 and/or an AoD of the set of sensing signals 412 based on a plurality of ports that transmitted the set of sensing signals 412 and a plurality of ports that received the reflected set of sensing signals 416. In one aspect, the wireless device 402 may calculate an AoA of the reflected set of sensing signals 420 and/or an AoD of the set of sensing signals 418 based on a plurality of ports that transmitted the set of sensing signals 418 and a plurality of ports that received the reflected set of sensing signals 420.

Similarly, the wireless device 404 may conduct one or more sensing measurements on the reflected set of sensing signals 414 and/or the reflected set of sensing signals 424. In one aspect, the wireless device 404 may calculate a distance or a range that the set of sensing signals 412 and the reflected set of sensing signals 414 travels based on a time between when the wireless device 402 transmits the set of sensing signals 412 and when the wireless device 404 receives the reflected set of sensing signals 414. In one aspect, the wireless device 404 may calculate a distance or a range that the set of sensing signals 422 and the reflected set of sensing signals 424 travels based on a time between when the wireless device 408 transmits the set of sensing signals 422 and when the wireless device 404 receives the reflected set of sensing signals 424. In one aspect, the wireless device 404 may calculate a location of the target object 403 based on a plurality or range or distance measurements, for example via triangulation using the known positions of wireless devices 402, 404, and 408, and the calculated range or distance measurements. In one aspect, the wireless device 404 may calculate a velocity of the target object 403 based on a first calculated location of the target object 403 based on the reflected set of sensing signals 414 and/or the reflected set of sensing signals 424 measured at a first time, and a second calculated location of the target object 403 based on the reflected set of sensing signals 414 and/or the reflected set of sensing signals 424 measured at a second time. In one aspect, the wireless device 404 may calculate an AoA of the reflected set of sensing signals 414 and/or an AoD of the set of sensing signals 412 based on a plurality of ports that transmitted the set of sensing signals 412 and a plurality of ports that received the reflected set of sensing signals 414. In one aspect, the wireless device 404 may calculate an AoA of the reflected set of sensing signals 424 and/or an AoD of the set of sensing signals 422 based on a plurality of ports that transmitted the set of sensing signals 422 and a plurality of ports that received the reflected set of sensing signals 424.

While a wireless device may sense parameters of the target object 403 by measuring a reflected set of sensing signals originating from a transmitter node, such a wireless device may improve its sensing by measuring two or more reflected sets of sensing signals originating from two or more transmitter nodes. For example, the wireless device 402 may improve its sensing by measuring the reflected set of sensing signals 416 originating from the wireless device 402 as the set of sensing signals 412 in addition to measuring the reflected set of sensing signals 420 originating from the wireless device 406 as the set of sensing signals 418. In another example, the wireless device 404 may improve its sensing by measuring the reflected set of sensing signals 414 originating from the wireless device 402 as the set of sensing signals 412 in addition to measuring the reflected set of sensing signals 424 originating from the wireless device 408 as the set of sensing signals 422.

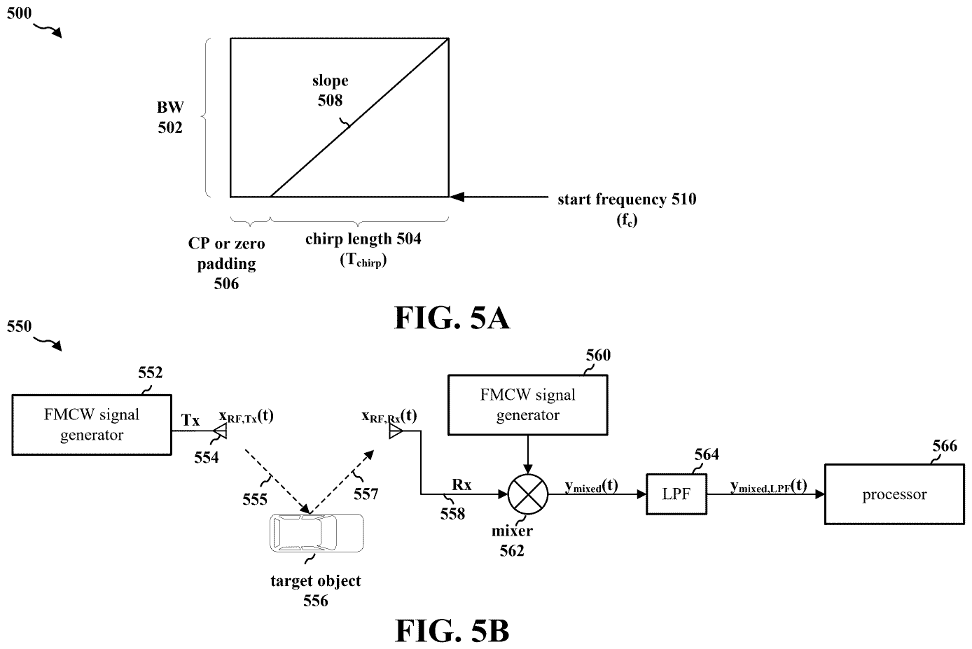

FIG. 5A is a diagram 500 illustrating an example of an FMCW chirp. A sensing signal may be based on such FMCW chirps, having a bandwidth 502 and a slope 508 that increases from a start frequency 510 (f_{c}) to the end of the chirp. In other words, the chirp length 504 (T_{chirp}) and the slope 508 may dictate the bandwidth 502 of the FMCW chirp. In some aspects, the beginning of a chirp may be padded with a cyclic prefix (CP) 506. In some aspects, the CP 506 may be zero, indicating zero padding before the FMCW chirp.

The maximum distance that a sensing signal based on an FMCW chirp may sense may be represented as

$$\frac{{F}_{s} c}{2 S} = \frac{{F}_{s} c {T}_{c h i r p}}{2 B W} .$$

Fₛ may be the sampling rate.
s may indicate the slope of the chirp, which may be calculated as

$$\frac{B W}{{T}_{c hirp}} .$$

BW may indicate the bandwidth of the chirp.
T_{chirp} may indicate the length of the chirp.

FIG. 5B is a diagram 550 illustrating an example of sensing based on a sensing signal, where the sensing signal may be a series of FMCW chirps, such as the FMCW chirp in FIG. 5A. A transmitting device may have an FMCW signal generator 552 may generate an FMCW signal based on a configuration, such as an offset, a chirp length, and a bandwidth. The FMCW signal generator may output the FMCW signal to the Tx antenna 554.

The transmitted FMCW signal may be designated as

$${x}_{RF , Tx} ( t ) = cos ( 2 π ( {f}_{c} + \frac{s}{2} t ) t + {ϕ}_{T R P} ) , S = \frac{B W}{{T}_{c hirp}} .$$

t may indicate the time, in seconds.
f_{c} may indicate the start frequency of the FMCW chirp.
φ_{TRP} may indicate the initial phase of the signal, for example a signal generated by RF chain hardware at a TRP.
s may indicate the slope of the chirp, which may be calculated as

$$\frac{B W}{{T}_{c hirp}} .$$

The signal frequency of the FMCW signal may increase with time as

$${f}_{T X} ( t ) = {f}_{c} + St , S = \frac{B W}{{T}_{c hirp}} .$$

The FMCW sensing signal 555 may reflect off of the target object 556 as the reflected FMCW sensing signal 557. A receiving device may have an Rx antenna 558 that receives the reflected FMCW sensing signal.

The received FMCW signal may be designated as

$${y}_{RF , Rx} ( t ) = {\sum }_{p = 0}^{P - 1} {A}_{p} {x}_{R F , T x} ( t - {τ}_{p} ) + n ( t ) .$$

t may indicate the time, in seconds.
P may indicate the number of periods in the FMCW signal
Aₚ may indicate the channel gain of a path p.
τₚ may indicate the estimated delay for the chirp, in seconds, of a path p.
n(t) may indicate the noise at time occasion t.

The receiving device may have an FMCW signal generator 560 configured to generate an FMCW signal based on a configuration. The configuration that the FMCW signal generator 560 uses may be the same as the configuration that the FMCW signal generator 552 uses. The mixer 562 may mix the received FMCW sensing signal with the generated FMCW signal from the FMCW signal generator 560. The low pass filter (LPF) 564 may filter the mixed FMCW signal to the processor 566 for measuring the sensing signal. The processor 566 may be a baseband sensing processor.

After mixing the received FMCW signal with the mixer 562 and filtering the mixed FMCW signal with the LPF 564, the filtered FMCW signal may be designated as

$${y}_{mixed , LPF} ( t ) = LPF [ {y}_{RF , Rx} ( t ) {x}_{RF , Rx} ( t ) ] = {\sum }_{p = 0}^{P - 1} {β}_{p} exp ( - j 2 π S {τ}_{p} \cdot t )$$

t may indicate the time, in seconds.
LPF[ ] may indicate the value of the signal after passing through the LPF.
βₚ may indicate equivalent channel gain of a path p.
τₚ may indicate the delay for the chirp, in seconds, of a path p.
S may indicate the slope of the chirp, which may be calculated as

$$S = \frac{B W}{{T}_{c h i r p}} .$$

The processor 566 may derive the distance of the target object 556 from the Rx antenna 558 based on the estimated delay values {τₚ}.

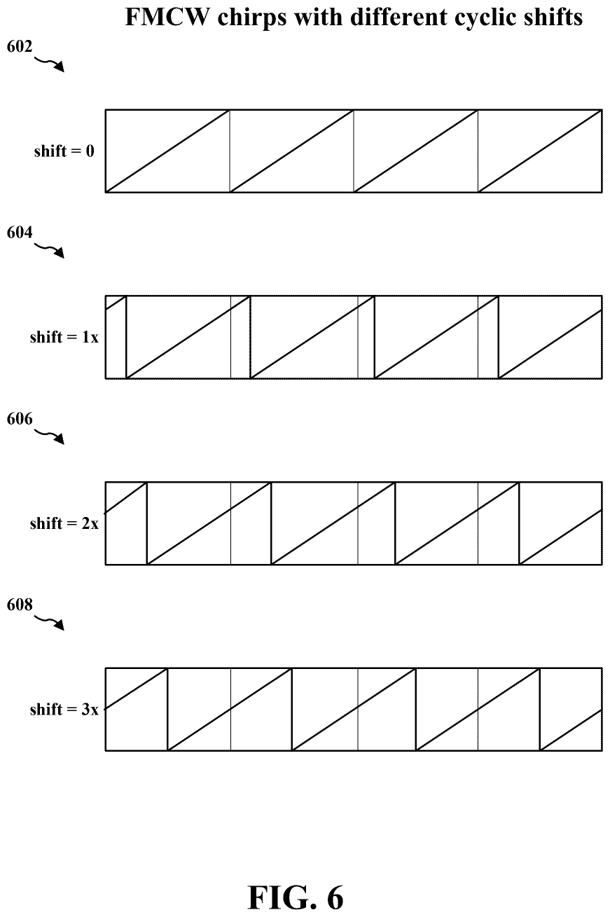

FIG. 6 has a plurality of diagrams 602, 604, 606, and 608 illustrating an example of FMCW-based communication signals having difference cyclic shifts. The diagram 602 illustrates four symbols of an FMCW-based communication signal having a cyclic shift of zero. The diagram 604 illustrates four symbols of an FMCW-based communication signal having a cyclic shift of 1×. The diagram 606 illustrates four symbols of an FMCW-based communication signal having a cyclic shift of 2×. The diagram 608 illustrates four symbols of an FMCW-based communication signal having a cyclic shift of 3×. As shown, the same cyclic shift value may be used in multiple symbols for enhancing the signal-to-noise (SNR) ratio and/or signal-to-interference and noise ratio (SINR) of the received FMCW signal.

Such FMCW-based communication signals may be categorized as a chirp-spread spectrum (CSS) based modulation scheme, which may be used for long range (LoRa) communication technologies. Such signals may be used in low-power wide area networks (LP-WAN). Such FMCW-based communication signals may also be suitable to provide a lower SINR/SNR, as FMCW-based communication signals have an efficient tradeoff between bandwidth and data rates when the signal may be drowned in noise (e.g., down to −149 dBm). Such FMCW-based communication signals may also be suitable to minimize in-band interference, as FMCW-based communication signals are resilient to fading and in-band interference. For example, a processor decoding an FMCW-based communication signal may decode packets in the presence of a 95 dB in-band single tone interference.

In some aspects, a spreading factor (SF) may be used, where a chirp may have 2^{SF} cyclic shift candidate values with an interval of

$$\frac{{T}_{c h i r p}}{{2}^{S F}} .$$

A transmitter that transmits an FMCW-based communication signal may select a set of cyclic shift values (e.g., from the setϵ{0, 1, . . . , 2^{SF}−1} based on data bits, and may transmit the cyclic shifted FMCW chirp signal as

$${x}_{RF , Tx} ( mod ( t + \frac{{s}^{*}}{{2}^{S F}} {T}_{c h irp} , {T}_{c hirp} ) ) .$$

In other words, up to SF bits may be represented by an FMCW chirp cyclic shift selection.

While an FMCW-based sensing signal may be used to perform sensing on a target object, a device of a sensing system, such as the transmitting device, may select a large chirp length (T_{chirp}) to increase the maximum sensing range, or to increase the post-processing SNR. In some aspects, the transmitting device may select a large chirp length if the target object has a small radio cross section (RCS) relative to other measured target objects in the same area. However, if such long FMCW chirps are used for sensing, and are not used for communication, the sensing system may have a low radio resource utilization ratio.

In order to improve the radio resource utilization ratio of a sensing system, a sensing system may utilize the same FMCW chirp for both sensing and communication, transmitting multiple FMCW chirps within the same time period with an offset. A transmitting device may use a number of time occasions within a duration of a T_{chirp}, where a set of offsets are used for sensing and a set of offsets are used for communication.

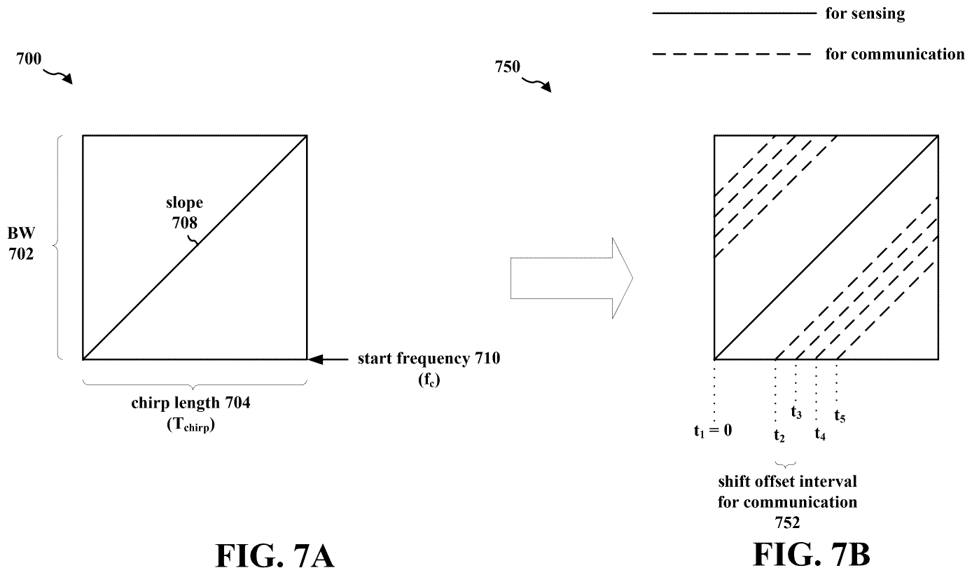

FIG. 7A is a diagram 700 illustrating an example of another FMCW chirp having a bandwidth 702, a chirp length 704, a start frequency 710, and a slope 708. The FMCW chirp may start at t=0 with the start frequency 710 and may linearly increase the frequency at a slope 708 to the bandwidth 702 at the end of the chirp length 704. In the next duration, the signal may start a new chirp at the start frequency 710.

FIG. 7B is a diagram 750 illustrating an example of a set of FMCW chirps based on the FMCW chirp in FIG. 7A. The set of FMCW chirps may be transmitted simultaneously based on the same bandwidth and the same duration with different shift offsets {t₁, t₂, t₃, t₄, t₅}. Some of the offsets may be used for sensing, such as the chirp starting at t₁, whereas other offsets may be used for communication such as t₂, t₃, t₄, and t₅. While the diagram 750 illustrates a single offset that may be used for sensing and a plurality of offsets that may be used for communication, in some aspects a plurality of offsets may be used for sensing and a single offset may be used for communication, or a plurality of offsets may be used for sensing and a plurality of offsets may be used for communication.

A transmitting device may use a number of time occasions within a T_{chirp} duration to transmit a sensing signal or a communication signal. Each time occasion may be associated with a shift offset {t₁, . . . , t_{N}} relative to the chirp start position. In some aspects, a first subset of the shift offsets may be used for sensing, and a second subset of the shift offsets may be used for communication. The first subset and the second subset may be non-overlapping.

In some aspects, a UE may provide shift offsets to a network node for the network node to select the subsets. In some aspects, the shift offsets may be associated with an indicator to use the offset for sensing or for communication. For example, as shown in diagram 750, a UE may provide a single offset t₁ associated with sensing and four offsets t₂, t₃, t₄, and t₅ associated with communication. Each of the offsets associated with a task may be offset by a shift offset interval, such as the shift offset interval 752 between the offsets t₂, t₃, t₄, and t₅ associated with communication. The network node may select from a set of offsets from the offsets t₂, t₃, t₄, and t₅ associated with communication for transmitting a communication signal by selecting the offsets based on data bits.

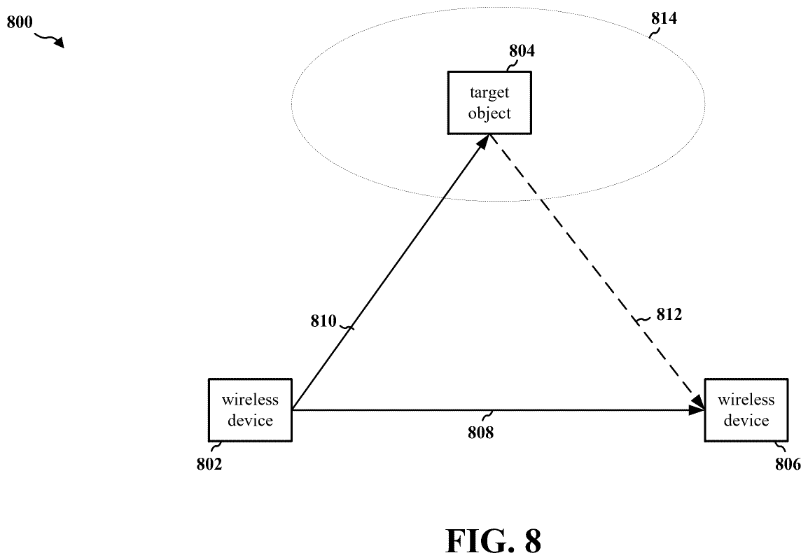

FIG. 8 is a diagram 800 illustrating an example of a wireless device 806 receiving both the set of reflected sensing signals 812 and a set of communication signals 808 originating from the wireless device 802. The wireless device 802 may be, for example, a UE, a TRP, or a network node. The wireless device 806 may be, for example, a UE, a TRP, or a network node. The wireless device 802 may be capable of transmitting both FMCW sensing signals and FMCW communication signals during the same time duration. The wireless device 802 may be capable of receiving both FMCW sensing signals and FMCW communication signals during the same time duration.

In some aspects, the wireless device 806 may be a low-end capability device, such as a UE with an analog-to-digital converter (ADC) with a low sampling rate, or an internet of things (IoT) device that is largely dedicated for sensing. To reduce cost, the wireless device 806 may be configured to transmit and receive FMCW signals, but not other types of signals that use higher capability hardware, such as LTE signals, NR signals, Wi-Fi signals, or NG-IoT signals.

In some aspects, the wireless device 806 may be a medium-end capability device or a high-end capability device, such as a UE with an ADC having a high sampling rate. The wireless device 806 may transmit and receive both FMCW signals and other legacy communication signals. The wireless device 806 may be configured to transmit and receive FMCW signals based on a mode of the wireless device 806, such as a power-saving mode or a radio resource-saving mode.

The wireless device 802 may transmit a set of sensing signals 810 at the sensing area 814. The set of sensing signals 810 may reflect off of the target object 804 as the set of reflected sensing signals 812. The wireless device 802 may also transmit the set of communication signals 808 at the wireless device 806. The wireless device 806 may receive the set of reflected sensing signals 812. The wireless device 806 may receive the set of communication signals 808. The wireless device 806 may receive both the set of reflected sensing signals 812 and the set of communication signals 808 during the same time duration.

The wireless device 802 may jointly/simultaneously transmit the set of sensing signals 810 and the set of communication signals 808 using FMCW chirps with the same bandwidth and duration, but different time shifts, such as the FMCW chirps shown in FIG. 7B. For example, the wireless device 802 may be a TRP with multiple RF hardware circuits and antennas, where each hardware circuit/antenna pair transmits a discrete FMCW chirp with a different shift offset. In order to avoid mutual interference of the signals at the wireless device 806, the wireless device 802 may configure the wireless device 806 to report joint CSI on the sensing-related parameters and communication-related parameters of FMCW chirps in a CSI-RS. The joint ISAC CSI report from the wireless device 806 to the wireless device 802 may include, for example, a chirp length for sensing, and a shift offset interval for communication.

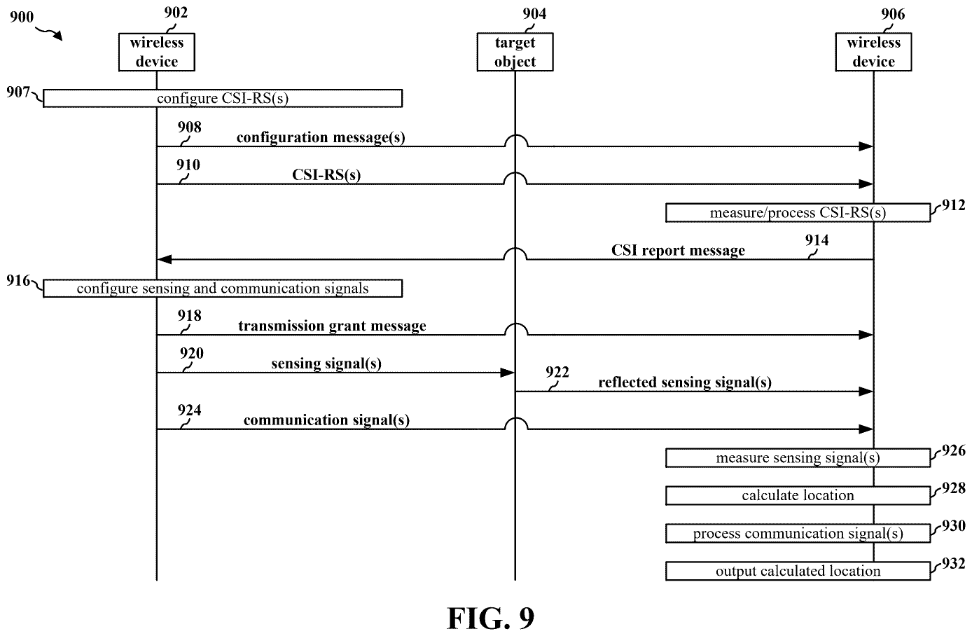

FIG. 9 is a communication flow diagram 900 illustrating an example of a wireless device 906 configured to receive both a sensing signal and a communication signal originating from the wireless device 902. The wireless device 902 may be a network node, a TRP, or a UE. The wireless device 906 may be a UE, a TRP, or a network node.

At 907, the wireless device 902 may configure the set of CSI-RSs 910. In other words, the wireless device 902 may configure FMCW-based CSI-RS configuration for the set of CSI-RSs 910 transmitted to the wireless device 906. The wireless device 902 may configure the FMCW-based CSI-RS configuration based on a maximum sensing range for the wireless device 906, which may be designated as R_{sensing,max}. The R_{sensing,max} may be calculated based on the maximum sensing distance for the set of sensing signals 920 to reach the target object 904 and reflect back to the wireless device 906 as the set of reflected sensing signals 922 associated with a quality indicator (e.g., having a reference signal received power (RSRP) value equal to or below a threshold value, having an SNR or an SINR that is greater or equal to a threshold value). In some aspects, known borders in a sensing area may be used to limit the length of R_{sensing,max}. For example, if the wireless device 902 configures a sensing session to sense an unmanned aerial vehicle (UAV) in a regulated area, the wireless device 902 may limit the height of sensed objects in an area to a maximum UAV height (e.g., 120 meters). In another example, if the wireless device 902 configures a sensing session to sense a vehicle on a road, the wireless device 902 may limit the height of sensed objects in an area to the borders of the road. In another example, if the wireless device 902 configures a sensing session to sense an object within a room, the wireless device 902 may limit the borders of sensed objects to the borders of the room. In other aspects, the wireless device 902 may calculate the length of R_{sensing,max} based on a position of the wireless device 902, the position of the wireless device 906, and the sensing area. For example, if the wireless device 902 is similar to the wireless device 802 in FIG. 8, the wireless device 802 may calculate a plurality of distances that the set of sensing signals 810 may reflect off of target objects within the sensing area 814 to reach the wireless device 806 as the set of reflected sensing signals 812 associated with a quality indicator to calculate the length of R_{sensing,max}. In other aspects, the wireless device 902 may not know the position/location of the wireless device 906, and may calculate the length of R_{sensing,max} based on the possible farthest UE position from a sensing area to receive a set of reflected sensing signals associated with a quality indicator. In some aspects, the FMCW-based CSI-RS configuration may include a set of chirp length and a set of offsets that the CSI-RS transmission of the set of CSI-RSs 910 follows.

In some aspects, the wireless device 902 may configure the sampling rate of the wireless device 906. For example, the wireless device 902 may be a network node that configures a UE sampling rate Fₛ. In such aspects, the wireless device 902 may calculate a chirp length for sensing (T_{chirp,sensing}) based on the configured Fₛ and the R_{sensing,max}. In such aspects, the wireless device 902 may configure the wireless device 906 to report the FMCW-based communication-related CSI based on the calculated T_{chirp,sensing}.

In some aspects, the wireless device 902 may not configure the sampling rate of the wireless device 906. For example, the wireless device 906 may configure its own sampling rate, or another device may configure the sampling rate of the wireless device 906. In aspects where the wireless device 902 may not calculate T_{chirp,sensing}, the wireless device 902 may transmit an indicator to the wireless device 906 of the calculated R_{sensing,max}. The wireless device 902 may configure the wireless device 906 to report the FMCW-based ISAC-related CSI based on the R_{sensing,max}.

The wireless device 902 may transmit a set of configuration messages 908 to the wireless device 906. The wireless device 906 may receive the set of configuration messages 908. The set of configuration messages 908 may include, for example, an RRC configuration, DCI, a MAC-CE, or a sidelink configuration message. The set of configuration messages 908 may include the FMCW-based CSI-RS configuration. The set of configuration messages 908 may include an FMCW-based ISAC CSI report configuration.

The FMCW-based CSI-RS configuration may configure the set of CSI-RSs 910. The FMCW-based CSI-RS configuration may include an indicator of a frequency domain assignment. For example, the FMCW-based CSI-RS configuration may include an indicator of a BW associated with the set of CSI-RSs 910. In another example, the FMCW-based CSI-RS configuration may include an indicator of a start frequency associated with the set of CSI-RSs 910. The FMCW-based CSI-RS configuration may include an indicator of a time domain assignment. For example, the FMCW-based CSI-RS configuration may include an indicator of the length of a chirp associated with the set of CSI-RSs 910 (e.g., a T_{chirp,csirs} value). In aspects where the wireless device 902 may calculate the value of T_{chirp,sensing}, the wireless device 902 may calculate the T_{chirp,csirs} to be greater or equal to T_{chirp,sensing}. In another example, the FMCW-based CSI-RS configuration may include an indicator of a time-domain position associated with the set of CSI-RSs 910. In another example, the FMCW-based CSI-RS configuration may include an indicator of a periodicity associated with the set of CSI-RSs 910. The FMCW-based CSI-RS configuration may indicate a shift offset associated with the set of CSI-RSs (e.g., the shift offset may be equal to zero, or may be configured by the FMCW-based CSI-RS configuration).

In some aspects, the FMCW-based CSI-RS configuration may configure a plurality of sensing tasks, where each sensing task is associated with a subset of the set of CSI-RSs 910. For example, if the wireless device 902 configures multiple sensing tasks (N_{sensing}), the wireless device 902 may transmit an R_{sensing,max,i} for each of the N_{sensing} from 1 to N_{sensing}.

The FMCW-based ISAC CSI report configuration may configure the CSI report message 914. In some aspects, the FMCW-based ISAC CSI report configuration may configure how the wireless device 906 may measure/process the set of CSI-RSs 910 at 912. For example, in aspects where the wireless device 902 may configure the wireless device 906 to report the FMCW-based communication-related CSI based on the calculated T_{chirp,sensing}, the FMCW-based ISAC CSI report configuration may include an indicator of Fₛ, and may include an indicator of T_{chirp,sensing}. In another example, in aspects where wireless device 902 may configure the wireless device 906 to report the FMCW-based ISAC-related CSI based on the R_{sensing,max}, the FMCW-based ISAC CSI report configuration may include an indicator of R_{sensing,max}. The FMCW-based ISAC CSI report configuration may configure the CSI report message 914 to include T_{chirp,sensing}, as the wireless device 902 may be unable to calculate T_{chirp,sensing} if the wireless device 902 does not have access to Fₛ. In some aspects, the FMCW-based ISAC CSI report configuration may configure the CSI report message 914 to include parameters of the ISAC-based FMCW chirp and the channel status (e.g., channel quality indicator (CQI)). In some aspects, the FMCW-based ISAC CSI report configuration may configure the CSI report message 914 to include a minimum inter-offset interval for communication (I_{offset,comm,min}). In some aspects, the FMCW-based ISAC CSI report configuration may configure the CSI report message 914 to include a CQI or a post-processing SNR (γₚₒₛₜ). For example, the wireless device 906 may calculate an SNR after multiplying the local FMCW chirp with the received signal, passing the mixed signal through an LPF, and performing FFT on the filtered signal. In some aspects, the FMCW-based ISAC CSI report configuration may configure the content in a report transmitted by the wireless device 906.

The wireless device 902 may transmit the set of CSI-RSs 910 to the wireless device 906. The wireless device 902 may transmit the set of CSI-RSs 910 based on the FMCW-based CSI-RS configuration transmitted to the wireless device 906. The wireless device 906 may receive the set of CSI-RSs 910 from the wireless device 902.

At 912, the wireless device 906 may measure the set of CSI-RSs 910 for ISAC. The wireless device 906 may measure the set of CSI-RSs 910 based on the FMCW-based ISAC CSI report configuration. In some aspects, the wireless device 906 may calculate the FMCW chirp parameters based on the FMCW-based ISAC CSI report configuration. In some aspects, the set of configuration messages 908 may include an indicator of T_{chirp,sensing} and an indicator of T_{chirp,csirs}. In some aspects, if the set of configuration messages 908 includes an indicator of T_{chirp,csirs} and does not include an indicator of T_{chirp,sensing}, the wireless device 906 may assume that T_{chirp,sensing}−T_{chirp,csirs}, and perform measurements based upon that assumption.

In some aspects, where the wireless device 906 configures its own Fₛ, or a device other than the wireless device 902 configures the Fₛ for the wireless device 906, the wireless device 906 may calculate T_{chirp,sensing} based on a sensing condition and the configured value of Fₛ. For example, the wireless device 906 may configure Fₛ, and may solve for T_{chirp,sensing} based on the formula

$${R}_{sensing , max} = \frac{{F}_{s} c {T}_{c h irp , sensing}}{2 B W} ,$$

where the set of configuration messages 908 may include an indicator of R_{sensing,max} and an indicator of BW. In other words, the wireless device 906 may solve for

$${T}_{chirp , senslng} = \frac{{R}_{sensing , max} \cdot 2 BW}{{F}_{s} c} .$$

In some aspects, where the wireless device 902 configures multiple sensing tasks (N_{sensing}), the wireless device 906 may solve for T_{chirp,sensing} based on each of the indicated

$${\{ {R}_{sensing , max , i} \}}_{i = 1}^{{N}_{s e n s i n g}} ,$$

for example by solving for

$${T}_{c h irp , sensing} = \frac{{\sum }_{i}^{{N}_{sensing}} {R}_{sensing , max , i} \cdot 2 BW}{{F}_{s} c} .$$

In some aspects, the wireless device 906 may be configured to calculate a minimum communication shift offset interval (I_{offset,comm,min}). For example, the wireless device 906 may calculate the I_{offset,comm,min} based on a minimum delay (τₘᵢₙ), a maximum delay (τₘₐₓ), and a post-processing SNR (γₚₒₛₜ).

The wireless device 906 may transmit the CSI report message 914 to the wireless device 902. The wireless device 902 may receive the CSI report message 914. The CSI report message 914 may include the calculated FMCW chirp parameters calculated at 912. The CSI report message 914 may include a channel quality indicator (CQI) associated with the set of CSI-RSs 910.

At 916, the wireless device 902 may configure the sensing and communication signals for transmission to the wireless device 906. In one aspect, the wireless device 902 may calculate an ISAC chirp length (e.g., T_{chirp,ISAC}), a set of sensing shift offsets (e.g., t_{offset,sensing,i}) for the set of sensing signals 920, and/or a set of communication shift offsets (e.g., t_{offset,comm,i}) for the set of communication signals 924. In one aspect, the wireless device 902 may calculate a channel coding rate for at least one of the set of sensing signals 920 and/or the set of communication signals 924 based on the CQI and/or based on the SNR in the CSI report message 914.

The wireless device 902 may transmit the transmission grant message 918 to the wireless device 906. The wireless device 906 may receive the transmission grant message 918 from the wireless device 902. The transmission grant message 918 may include an FMCW sensing and communication configuration to assist the wireless device 906 in configuring reception of both the set of reflected sensing signals 922 and the set of communication signals 924. The FMCW sensing and communication configuration may include an indicator of a set of FMCW sensing offsets. The set of FMCW sensing offsets may correspond with the set of sensing signals 920. In other words, the set of sensing signals 920 may be transmitted using the FMCW sensing offsets. The FMCW sensing and communication configuration may include an indicator of a set of FMCW communication offsets. The set of FMCW communication offsets may correspond with the set of communication signals 924. In other words, the set of communication signals 924 may be transmitted using the FMCW communication offsets.

The wireless device 902 may transmit the set of sensing signals 920. The wireless device 902 may transmit the set of sensing signals 920 based on the FMCW sensing and communication configuration. The wireless device 902 may transmit the set of sensing signals 920 based on the set of FMCW sensing offsets. The set of sensing signals 920 may reflect off of the target object 904 as the set of reflected sensing signals 922. The wireless device 906 may receive the set of reflected sensing signals 922 reflected off of the target object 904.

The wireless device 902 may transmit the set of communication signals 924 at the wireless device 906. The wireless device 906 may receive the set of communication signals 924 from the wireless device 902. The wireless device 902 may transmit the set of communication signals 924 based on the FMCW sensing and communication configuration. The wireless device 902 may transmit the set of communication signals 924 based on the set of FMCW communication offsets.

The wireless device 902 may transmit the set of communication signals 924 and the set of sensing signals 920 using the same bandwidth and during the same duration. In other words, both the set of communication signals 924 and the set of sensing signals 920 may share the same BW and the same T_{chirp}, but may start at different offsets based on the FMCW sensing and communication configuration configured at 916.

The wireless device 906 may receive the set of communication signals 924 and the set of sensing signals 920 using the same bandwidth and during the same duration. The wireless device 906 may filter the set of communication signals 924 and the set of sensing signals 920 from one another based on the set of sensing signal offsets and the set of communication signal offsets from the FMCW sensing and communication configuration.

At 926, the wireless device 906 may measure the set of reflected sensing signals 922. At 928, the wireless device 906 may calculate a location of the target object 904. At 932, the wireless device 906 may output the calculated location of the target object 904. For example, the wireless device 906 may transmit the calculated location of the target object in a report message that is transmitted to another wireless device, such as the wireless device 902 or a component of a core network, such as an LMF. In another example, the wireless device 906 may output the calculated location of the target object to a component of the wireless device 906, which may save the calculated location to a memory, such as a drive or a cache, of the wireless device 906.

At 930, the wireless device 906 may process the set of communication signals 924. For example, the wireless device 906 may decode the set of communication signals 924 and follow a set of instructions in according to the decoded signals.

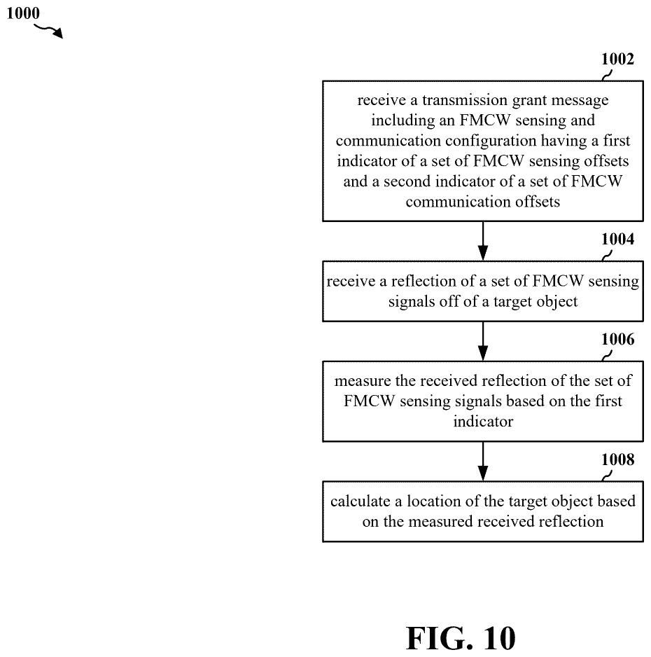

FIG. 10 is a flowchart 1000 of a method of wireless communication. The method may be performed by a UE (e.g., the UE 104, the UE 350; the wireless device 402, the wireless device 404, the wireless device 406, the wireless device 408, the wireless device 806, the wireless device 906; the processor 566; the apparatus 1204). At 1002, the UE may receive a transmission grant message. The transmission grant message may include an FMCW sensing and communication configuration. The FMCW sensing and communication configuration may have a first indicator of a set of FMCW sensing offsets and a second indicator of a set of FMCW communication offsets. For example, 1002 may be performed by the wireless device 906 in FIG. 9, which may receive the transmission grant message 918. The transmission grant message 918 may include an FMCW sensing and communication configuration. The FMCW sensing and communication configuration may have a first indicator of a set of FMCW sensing offsets and a second indicator of a set of FMCW communication offsets. The set of FMCW sensing offsets may correspond with the set of sensing signals 920. The set of FMCW communication offsets may correspond with the set of communication signals 924. Moreover, 1002 may be performed by the component 198 in FIG. 1, 3, or 12.

At 1004, the UE may receive a reflection of a set of FMCW sensing signals off of a target object. For example, 1004 may be performed by the wireless device 906 in FIG. 9, which may receive the set of reflected sensing signals 922. The set of reflected sensing signals 922 may be a reflection of the set of sensing signals 920 off of the target object 904. Moreover, 1004 may be performed by the component 198 in FIG. 1, 3, or 12.

At 1006, the UE may measure the received reflection of the set of FMCW sensing signals based on the first indicator. For example, 1006 may be performed by the wireless device 906 in FIG. 9, which may, at 926, measure the set of reflected sensing signals 922 based on the first indicator. Moreover, 1006 may be performed by the component 198 in FIG. 1, 3, or 12.

At 1008, the UE may calculate a location of the target object based on the measured received reflection. For example, 1008 may be performed by the wireless device 906 in FIG. 9, which may, at 928, calculate a location of the target object 904 based on the measurements taken at 926. Moreover, 1008 may be performed by the component 198 in FIG. 1, 3, or 12.

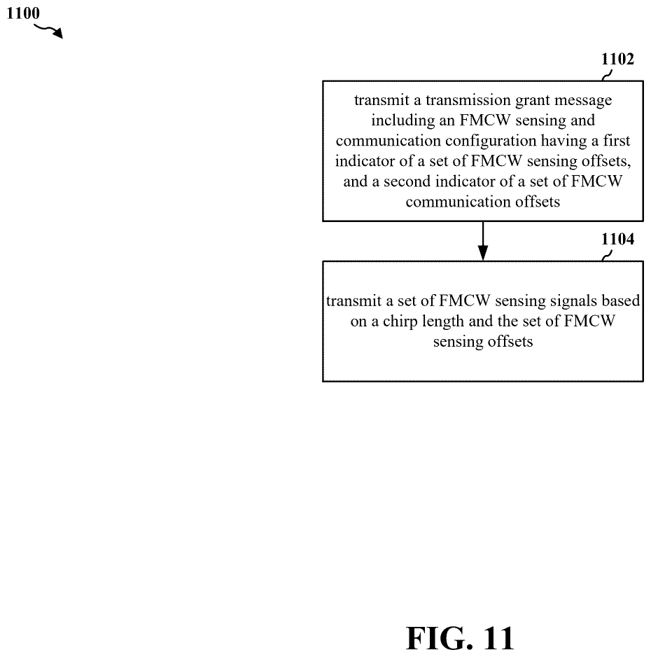

FIG. 11 is a flowchart 1100 of a method of wireless communication. The method may be performed by a network node (e.g., the base station 102, the base station 310; the wireless device 402, the wireless device 404, the wireless device 406, the wireless device 408, the wireless device 802, the wireless device 902; the network entity 1202, the network entity 1302, the network entity 1460). At 1102, the network node may transmit a transmission grant message. The transmission grant message may include an FMCW sensing and communication configuration. The FMCW sensing and communication configuration may include a first indicator of a set of FMCW sensing offsets, and a second indicator of a set of FMCW communication offsets. For example, 1102 may be performed by the wireless device 902 in FIG. 9, which may transmit the transmission grant message 918. The transmission grant message 918 may include an FMCW sensing and communication configuration. The FMCW sensing and communication configuration may include a first indicator of a set of FMCW sensing offsets, and a second indicator of a set of FMCW communication offsets. The set of FMCW sensing offsets may correspond with the set of sensing signals 920. The set of FMCW communication offsets may correspond with the set of communication signals 924. Moreover, 1102 may be performed by the component 199 in FIG. 1, 3, 13, or 14.

At 1104, the network node may transmit a set of FMCW sensing signals based on a chirp length and the set of FMCW sensing offsets. For example, 1104 may be performed by the wireless device 902 in FIG. 9, which may transmit the set of sensing signals 920 based on a chirp length and the set of FMCW sensing offsets. Moreover, 1104 may be performed by the component 199 in FIG. 1, 3, 13, or 14.

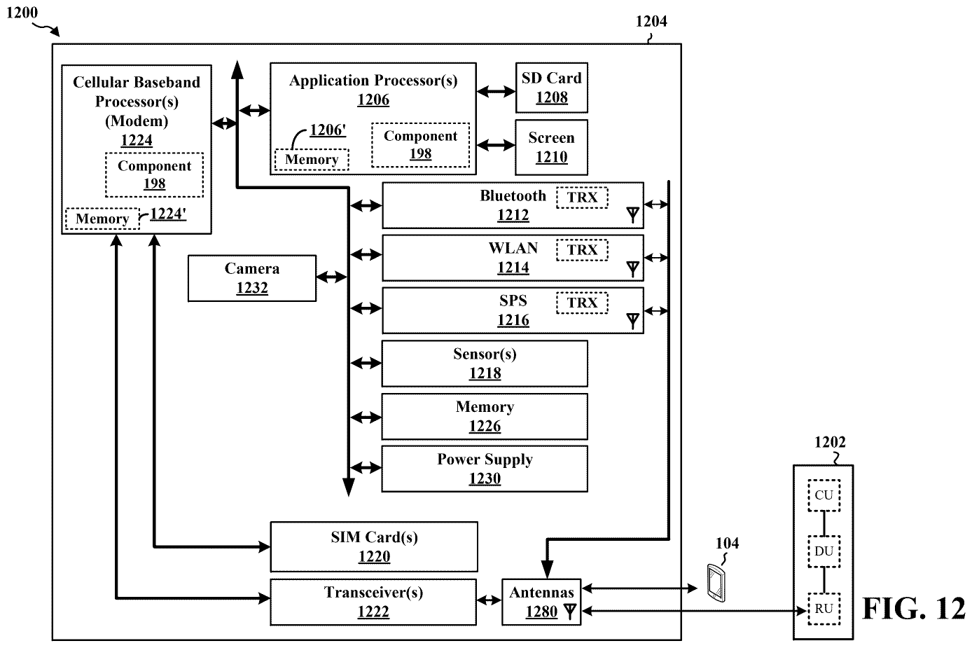

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the component 198 may be configured to receive a transmission grant message. The transmission grant message may include an FMCW sensing and communication configuration. The FMCW sensing and communication configuration may include a first indicator of a set of FMCW sensing offsets and a second indicator of a set of FMCW communication offsets. The component 198 may be configured to receive a reflection of a set of FMCW sensing signals off of a target object. The component 198 may be configured to measure the received reflection of the set of FMCW sensing signals based on the first indicator. The component 198 may be configured to calculate a location of the target object based on the measured received reflection. The component 198 may be configured to receive a set of FMCW communication signals. The component 198 may be configured to process the set of FMCW communication signals based on the second indicator. The component 198 may be configured to output a third indicator of the calculated location of the target object, for example by transmitting the third indicator or by storing the third indicator on a memory (e.g., memory 1224′, memory 1206′, and/or memory 1226) of the apparatus 1204. The component 198 may be within the cellular baseband processor(s) 1224, the application processor(s) 1206, or both the cellular baseband processor(s) 1224 and the application processor(s) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for receiving a transmission grant message. The transmission grant message may include an FMCW sensing and communication configuration including a first indicator of a set of FMCW sensing offsets and a second indicator of a set of FMCW communication offsets. The apparatus 1204 may include means for receiving a reflection of a set of FMCW sensing signals off of a target object. The apparatus 1204 may include means for measuring the received reflection of the set of FMCW sensing signals based on the first indicator. The apparatus 1204 may include means for calculating a location of the target object based on the measured received reflection. The apparatus 1204 may include means for outputting a third indicator of the calculated location of the target object. The apparatus 1204 may include means for outputting the third indicator of the calculated location of the target object by transmitting the third indicator of the calculated location of the target object or by storing the third indicator of the calculated location of the target object. The apparatus 1204 may include means for receiving a set of FMCW communication signals. The apparatus 1204 may include means for processing the set of FMCW communication signals based on the second indicator. The apparatus 1204 may include means for receiving at least one configuration message including an FMCW-based CSI-RS configuration and an FMCW-based ISAC CSI report configuration. The apparatus 1204 may include means for receiving an FMCW-based CSI-RS. The apparatus 1204 may include means for measuring the FMCW-based CSI-RS based on the FMCW-based CSI-RS configuration. The apparatus 1204 may include means for transmitting a CSI report message including a CSI report based on the measured FMCW-based CSI-RS and the FMCW-based ISAC CSI report configuration. The FMCW-based CSI-RS configuration may include a third indicator of a sampling rate. The FMCW-based CSI-RS configuration may include a fourth indicator of a sensing chirp length. The apparatus 1204 may include means for measuring the FMCW-based CSI-RS by measuring the FMCW-based CSI-RS based on the third indicator and the fourth indicator. The FMCW-based CSI-RS configuration may include a third indicator of a maximum sensing range. The apparatus 1204 may include means for measuring the FMCW-based CSI-RS by measuring the FMCW-based CSI-RS based on the third indicator. The apparatus 1204 may include means for measuring the received reflection of the set of FMCW sensing signals based on the first indicator by measuring the received reflection of the set of FMCW sensing signals further based on the third indicator. The apparatus 1204 may include means for processing the set of FMCW communication signals based on the second indicator by processing the set of FMCW communication signals further based on the third indicator. The apparatus 1204 may include means for measuring the FMCW-based CSI-RS based on the third indicator (1) by calculating a sensing chirp length based on the maximum sensing range, and (2) by measuring the FMCW-based CSI-RS based on the sensing chirp length. The CSI report may include a fourth indicator of the sensing chirp length. The apparatus 1204 may include means for measuring the received reflection of the set of FMCW sensing signals based on the first indicator by measuring the received reflection of the set of FMCW sensing signals further based on the sensing chirp length. The apparatus 1204 may include means for processing the set of FMCW communication signals based on the second indicator by processing the set of FMCW communication signals further based on the sensing chirp length. The FMCW-based CSI-RS configuration may include at least one of (1) a third indicator of a configured shift offset, (2) a fourth indicator of a start frequency, (3) a fifth indicator of a bandwidth, (4) a sixth indicator of a time-domain position, (5) a seventh indicator of a CSI-RS chirp length, or (6) an eighth indicator of a periodicity. The CSI report may include a third indicator of a minimum inter-offset interval. The set of FMCW sensing offsets may be based on the third indicator. The set of FMCW communication offsets may be based on the third indicator. The CSI report may include at least one of (1) a third indicator of a minimum inter-offset interval, (2) a CQI associated with the measured FMCW-based CSI-RS, or (3) a fourth indicator of an SNR associated with the measured FMCW-based CSI-RS. The FMCW sensing and communication configuration may include a third indicator of a chirp length. The apparatus 1204 may include means for measuring the received reflection of the set of FMCW sensing signals based on the first indicator may include measuring the received reflection of the set of FMCW sensing signals further based on the third indicator. The apparatus 1204 may include means for processing the set of FMCW communication signals based on the second indicator by processing the set of FMCW communication signals further based on the third indicator. The set of FMCW sensing signals and the set of FMCW communication signals may share a same bandwidth. The set of FMCW sensing signals and the set of FMCW communication signals may share a same duration. The set of FMCW sensing signals and the set of FMCW communication signals may be transmitted within the same time period. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

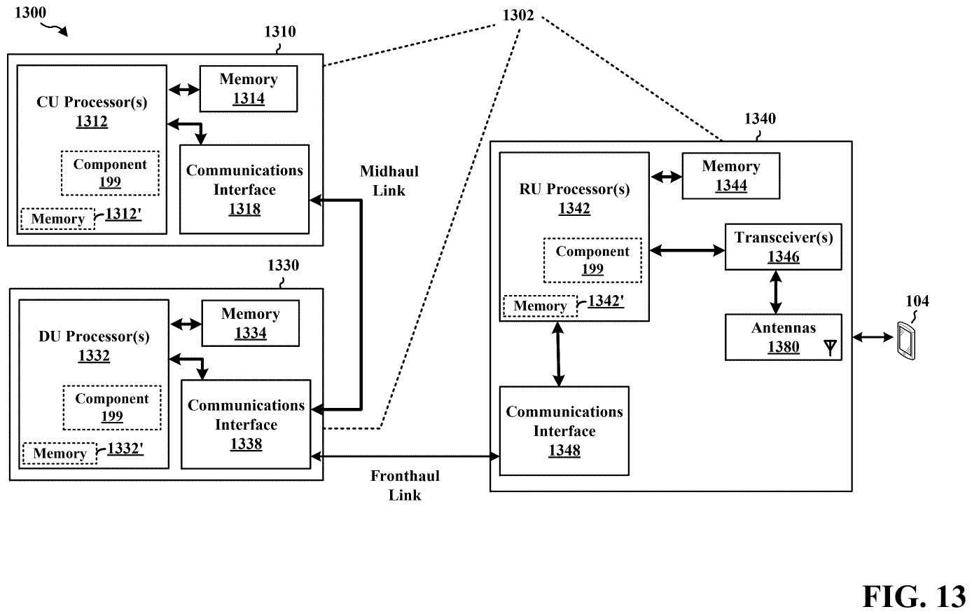

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor 1312. The CU processor(s) 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor 1332. The DU processor(s) 1332 may include on-chip memory 1332′. In some aspects, the DU 1330 may further include additional memory modules 1334 and a communications interface 1338. The DU 1330 communicates with the RU 1340 through a fronthaul link. The RU 1340 may include at least one RU processor 1342. The RU processor(s) 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit a transmission grant message. The transmission grant message may include an FMCW sensing and communication configuration. The FMCW sensing and communication configuration may include a first indicator of a set of FMCW sensing offsets, and a second indicator of a set of FMCW communication offsets. The component 199 may be configured to transmit a set of FMCW sensing signals based on a chirp length and the set of FMCW sensing offsets. The component 199 may be configured to transmit a set of FMCW communication signals based on the set of FMCW communication offsets. The sensing and communication signal transmission component 199 may be configured to receive a third indicator of a location of a target object based on the set of FMCW sensing signals. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 may include means for transmitting a transmission grant message. The transmission grant message may include an FMCW sensing and communication configuration including a first indicator of a set of FMCW sensing offsets and a second indicator of a set of FMCW communication offsets. The network entity 1302 may include means for transmitting a set of FMCW sensing signals based on a chirp length and the set of FMCW sensing offsets. The network entity 1302 may include means for transmitting a set of FMCW communication signals based on the set of FMCW communication offsets. The network entity 1302 may include means for transmitting at least one configuration message including an FMCW-based CSI-RS configuration and an FMCW-based ISAC CSI report configuration. The network entity 1302 may include means for transmitting an FMCW-based CSI-RS based on the FMCW-based CSI-RS configuration. The network entity 1302 may include means for receiving a CSI report message including a CSI report based on the transmitted FMCW-based CSI-RS and the FMCW-based ISAC CSI report configuration. The network entity 1302 may include means for calculating a sensing chirp length based on a sampling rate and a maximum sensing range. The FMCW-based ISAC CSI report configuration may include a third indicator of the sampling rate. The FMCW-based ISAC CSI report configuration may include a fourth indicator of the calculated sensing chirp length. The FMCW-based ISAC CSI report configuration may include a third indicator of a maximum sensing range. The CSI report may include a fourth indicator of a sensing chirp length. The FMCW-based CSI-RS configuration may include at least one of (1) a third indicator of a configured shift offset, (2) a fourth indicator of a start frequency, (3) a fifth indicator of a bandwidth, (4) a sixth indicator of a time-domain position, (5) a seventh indicator of a CSI-RS chirp length, or (6) an eighth indicator of a periodicity. The CSI report may include a third indicator of a minimum inter-offset interval. The network entity 1302 may include means for calculating the set of FMCW sensing offsets based on the third indicator. The network entity 1302 may include means for calculating the set of FMCW communication signals based on the third indicator. The CSI report may include at least one of (1) a third indicator of a minimum inter-offset interval, (2) a CQI associated with the transmitted FMCW-based CSI-RS, or (3) a fourth indicator of an SNR associated with the transmitted FMCW-based CSI-RS. The FMCW sensing and communication configuration may include a third indicator of the chirp length. The set of FMCW sensing signals and the set of FMCW communication signals may share a same bandwidth. The set of FMCW sensing signals and the set of FMCW communication signals may share a same duration. The set of FMCW sensing signals and the set of FMCW communication signals may be transmitted during the same time period. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

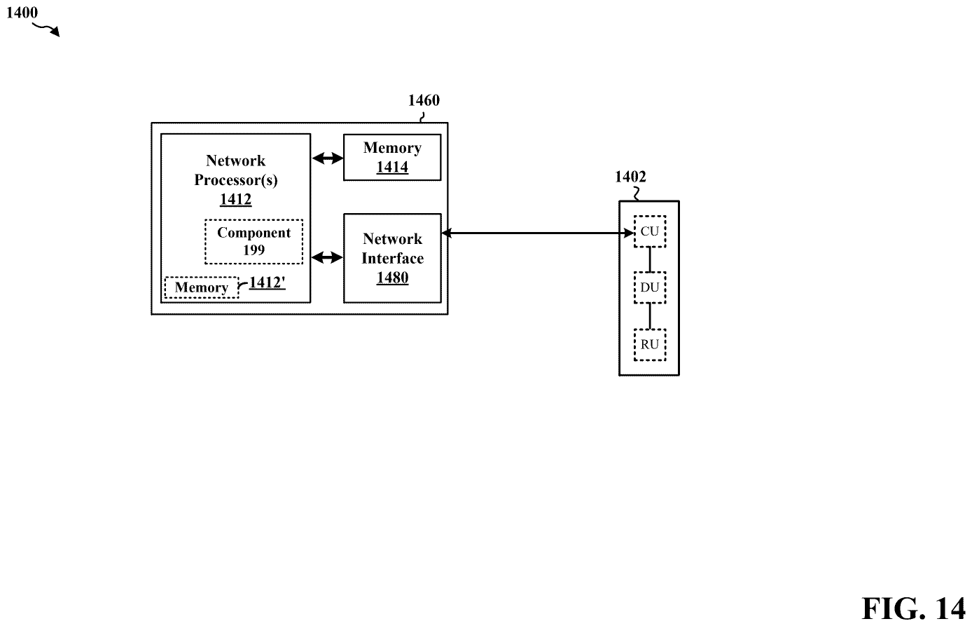

FIG. 14 is a diagram 1400 illustrating an example of a hardware implementation for a network entity 1460. In one example, the network entity 1460 may be within the core network 120. The network entity 1460 may include at least one network processor 1412. The network processor(s) 1412 may include on-chip memory 1412′. In some aspects, the network entity 1460 may further include additional memory modules 1414. The network entity 1460 communicates via the network interface 1480 directly (e.g., backhaul link) or indirectly (e.g., through a RIC) with the CU 1402. The on-chip memory 1412′ and the additional memory modules 1414 may each be considered a computer-readable medium/memory. Each computer-readable medium/memory may be non-transitory. The network processor(s) 1412 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit a transmission grant message. The transmission grant message may include an FMCW sensing and communication configuration. The FMCW sensing and communication configuration may include a first indicator of a set of FMCW sensing offsets, and a second indicator of a set of FMCW communication offsets. The component 199 may be configured to transmit a set of FMCW sensing signals based on a chirp length and the set of FMCW sensing offsets. The component 199 may be configured to transmit a set of FMCW communication signals based on the set of FMCW communication offsets. The sensing and communication signal transmission component 199 may be configured to receive a third indicator of a location of a target object based on the set of FMCW sensing signals. The component 199 may be within the network processor(s) 1412. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1460 may include a variety of components configured for various functions. In one configuration, the network entity 1460 may include means for transmitting a transmission grant message. The transmission grant message may include an FMCW sensing and communication configuration including a first indicator of a set of FMCW sensing offsets and a second indicator of a set of FMCW communication offsets. The network entity 1460 may include means for transmitting a set of FMCW sensing signals based on a chirp length and the set of FMCW sensing offsets. The network entity 1460 may include means for transmitting a set of FMCW communication signals based on the set of FMCW communication offsets. The network entity 1460 may include means for transmitting at least one configuration message including an FMCW-based CSI-RS configuration and an FMCW-based ISAC CSI report configuration. The network entity 1460 may include means for transmitting an FMCW-based CSI-RS based on the FMCW-based CSI-RS configuration. The network entity 1460 may include means for receiving a CSI report message including a CSI report based on the transmitted FMCW-based CSI-RS and the FMCW-based ISAC CSI report configuration. The network entity 1460 may include means for calculating a sensing chirp length based on a sampling rate and a maximum sensing range. The FMCW-based ISAC CSI report configuration may include a third indicator of the sampling rate. The FMCW-based ISAC CSI report configuration may include a fourth indicator of the calculated sensing chirp length. The FMCW-based ISAC CSI report configuration may include a third indicator of a maximum sensing range. The CSI report may include a fourth indicator of a sensing chirp length. The FMCW-based CSI-RS configuration may include at least one of (1) a third indicator of a configured shift offset, (2) a fourth indicator of a start frequency, (3) a fifth indicator of a bandwidth, (4) a sixth indicator of a time-domain position, (5) a seventh indicator of a CSI-RS chirp length, or (6) an eighth indicator of a periodicity. The CSI report may include a third indicator of a minimum inter-offset interval. The network entity 1460 may include means for calculating the set of FMCW sensing offsets based on the third indicator. The network entity 1460 may include means for calculating the set of FMCW communication signals based on the third indicator. The CSI report may include at least one of (1) a third indicator of a minimum inter-offset interval, (2) a CQI associated with the transmitted FMCW-based CSI-RS, or (3) a fourth indicator of an SNR associated with the transmitted FMCW-based CSI-RS. The FMCW sensing and communication configuration may include a third indicator of the chirp length. The set of FMCW sensing signals and the set of FMCW communication signals may share a same bandwidth. The set of FMCW sensing signals and the set of FMCW communication signals may share a same duration. The set of FMCW sensing signals and the set of FMCW communication signals may be transmitted during the same time period. The means may be the component 199 of the network entity 1460 configured to the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, may send the data to a device that transmits the data, or may output the data to a component of the device. A device configured to “obtain” data, such as a transmission, signal, or message, may receive, for example with a transceiver, may obtain the data from a device that receives the data, or may obtain the data from a component of the device. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a wireless device, comprising: receiving a transmission grant message comprising a frequency-modulated continuous wave (FMCW) sensing and communication configuration including a first indicator of a set of FMCW sensing offsets and a second indicator of a set of FMCW communication offsets; receiving a reflection of a set of FMCW sensing signals off of a target object; measuring the received reflection of the set of FMCW sensing signals based on the first indicator; and calculating a location of the target object based on the measured received reflection.

Aspect 2 is the method of aspect 1, further comprising outputting a third indicator of the calculated location of the target object.

Aspect 3 is the method of aspect 2, wherein outputting the third indicator of the calculated location of the target object comprises: transmitting the third indicator of the calculated location of the target object; or storing the third indicator of the calculated location of the target object.

Aspect 4 is the method of aspect 1, further comprising: receiving a set of FMCW communication signals; and processing the set of FMCW communication signals based on the second indicator.

Aspect 5 is the method of aspect 1, further comprising: receiving at least one configuration message comprising an FMCW-based CSI-RS configuration and an FMCW-based integrated sensing and communication (ISAC) CSI report configuration; receiving an FMCW-based CSI-RS; measuring the FMCW-based CSI-RS based on the FMCW-based CSI-RS configuration; and transmitting a CSI report message comprising a CSI report based on the measured FMCW-based CSI-RS and the FMCW-based ISAC CSI report configuration.

Aspect 6 is the method of aspect 5, wherein the FMCW-based CSI-RS configuration comprises a third indicator of a sampling rate and a fourth indicator of a sensing chirp length, wherein measuring the FMCW-based CSI-RS comprises measuring the FMCW-based CSI-RS based on the third indicator and the fourth indicator.

Aspect 7 is the method of aspect 5, wherein the FMCW-based CSI-RS configuration comprises a third indicator of a maximum sensing range, wherein measuring the FMCW-based CSI-RS comprises measuring the FMCW-based CSI-RS based on the third indicator.

Aspect 8 is the method of aspect 7, wherein measuring the received reflection of the set of FMCW sensing signals based on the first indicator comprises measuring the received reflection of the set of FMCW sensing signals further based on the third indicator, wherein processing the set of FMCW communication signals based on the second indicator comprises processing the set of FMCW communication signals further based on the third indicator.

Aspect 9 is the method of aspect 7, wherein measuring the FMCW-based CSI-RS based on the third indicator comprises: calculating a sensing chirp length based on the maximum sensing range; and measuring the FMCW-based CSI-RS based on the sensing chirp length, wherein the CSI report comprises a fourth indicator of the sensing chirp length.

Aspect 10 is the method of aspect 9, wherein measuring the received reflection of the set of FMCW sensing signals based on the first indicator comprises measuring the received reflection of the set of FMCW sensing signals further based on the sensing chirp length, wherein processing the set of FMCW communication signals based on the second indicator comprises processing the set of FMCW communication signals further based on the sensing chirp length.

Aspect 11 is the method of aspect 5, wherein the FMCW-based CSI-RS configuration comprises at least one of: a third indicator of a configured shift offset; a fourth indicator of a start frequency; a fifth indicator of a bandwidth; a sixth indicator of a time-domain position; a seventh indicator of a CSI-RS chirp length; or an eighth indicator of a periodicity.

Aspect 12 is the method of aspect 5, wherein the CSI report comprises a third indicator of a minimum inter-offset interval, wherein the set of FMCW sensing offsets are based on the third indicator; and the set of FMCW communication offsets are based on the third indicator.

Aspect 13 is the method of aspect 5, wherein the CSI report comprises at least one of: a third indicator of a minimum inter-offset interval; a channel quality indicator (CQI) associated with the measured FMCW-based CSI-RS; or a fourth indicator of a signal-to-noise ratio (SNR) associated with the measured FMCW-based CSI-RS.

Aspect 14 is the method of aspect 1, wherein the FMCW sensing and communication configuration further comprises a third indicator of a chirp length, wherein measuring the received reflection of the set of FMCW sensing signals based on the first indicator comprises measuring the received reflection of the set of FMCW sensing signals further based on the third indicator, wherein processing the set of FMCW communication signals based on the second indicator comprises processing the set of FMCW communication signals further based on the third indicator.

Aspect 15 is the method of aspect 1, wherein the set of FMCW sensing signals and the set of FMCW communication signals share a same bandwidth and share a same duration.

Aspect 16 is a method of wireless communication at a network node, comprising: transmitting a transmission grant message comprising a frequency-modulated continuous wave (FMCW) sensing and communication configuration including a first indicator of a set of FMCW sensing offsets, and a second indicator of a set of FMCW communication offsets; and transmitting a set of FMCW sensing signals based on a chirp length and the set of FMCW sensing offsets.

Aspect 17 is the method of aspect 16, further comprising transmitting a set of FMCW communication signals based on the set of FMCW communication offsets.

Aspect 18 is the method of aspect 16, further comprising: transmitting at least one configuration message comprising an FMCW-based CSI-RS configuration and an FMCW-based integrated sensing and communication (ISAC) CSI report configuration; transmitting an FMCW-based CSI-RS based on the FMCW-based CSI-RS configuration; and receiving a CSI report message comprising a CSI report based on the transmitted FMCW-based CSI-RS and the FMCW-based ISAC CSI report configuration.

Aspect 19 is the method of aspect 18, further comprising calculating a sensing chirp length based on a sampling rate and a maximum sensing range, wherein the FMCW-based ISAC CSI report configuration comprises a third indicator of the sampling rate and a fourth indicator of the calculated sensing chirp length.

Aspect 20 is the method of aspect 18, wherein the FMCW-based ISAC CSI report configuration comprises a third indicator of a maximum sensing range, wherein the CSI report comprises a fourth indicator of a sensing chirp length.

Aspect 21 is the method of aspect 18, wherein the FMCW-based CSI-RS configuration comprises at least one of: a third indicator of a configured shift offset; a fourth indicator of a start frequency; a fifth indicator of a bandwidth; a sixth indicator of a time-domain position; a seventh indicator of a CSI-RS chirp length; or an eighth indicator of a periodicity.

Aspect 22 is the method of aspect 18, wherein the CSI report comprises a third indicator of a minimum inter-offset interval. The method may include calculating the set of FMCW sensing offsets based on the third indicator and calculating the set of FMCW communication signals based on the third indicator.

Aspect 23 is the method of aspect 18, wherein the CSI report comprises at least one of: a third indicator of a minimum inter-offset interval; a channel quality indicator (CQI) associated with the transmitted FMCW-based CSI-RS; or a fourth indicator of a signal-to-noise ratio (SNR) associated with the transmitted FMCW-based CSI-RS.

Aspect 24 is the method of aspect 16, wherein the FMCW sensing and communication configuration further comprises a third indicator of the chirp length.

Aspect 25 is the method of aspect 16, wherein the set of FMCW sensing signals and the set of FMCW communication signals share a same bandwidth and share a same duration.

Aspect 26 is an apparatus for wireless communication, including: at least one memory; and at least one processor coupled to the at least one memory and, based at least in part on information stored in the at least one memory, the at least one processor, individually or in any combination, is configured to implement any of aspects 1 to 25.

Aspect 27 is the apparatus of aspect 26, further including at least one of an antenna or a transceiver coupled to the at least one processor.

Aspect 28 is an apparatus for wireless communication including means for implementing any of aspects 1 to 25.

Aspect 29 is a computer-readable medium (e.g., a non-transitory computer-readable medium) storing computer executable code, where the code, when executed by at least one processor, causes the at least one processor, individually or in any combination, to implement any of aspects 1 to 25.

1. An apparatus for wireless communication at a wireless device, comprising:
at least one memory; and
at least one processor coupled to the at least one memory and, based at least in part on information stored in the at least one memory, the at least one processor is configured to:
receive a transmission grant message comprising a frequency-modulated continuous wave (FMCW) sensing and communication configuration including a first indicator of a set of FMCW sensing offsets and a second indicator of a set of FMCW communication offsets;
receive a reflection of a set of FMCW sensing signals off of a target object;
measure the received reflection of the set of FMCW sensing signals based on the first indicator; and
calculate a location of the target object based on the measured received reflection.

2. The apparatus of claim 1, wherein the at least one processor is further configured to:
output a third indicator of the calculated location of the target object.

3. The apparatus of claim 2, wherein, to output the third indicator of the calculated location of the target object, the at least one processor is configured to:
transmit a report message comprising the third indicator of the calculated location of the target object; or
store the third indicator of the calculated location of the target object in the at least one memory.

4. The apparatus of claim 1, wherein the at least one processor is further configured to:
receive a set of FMCW communication signals; and
process the set of FMCW communication signals based on the second indicator.

5. The apparatus of claim 1, wherein the at least one processor is further configured to:
receive at least one configuration message comprising an FMCW-based CSI-RS configuration and an FMCW-based integrated sensing and communication (ISAC) CSI report configuration;
receive an FMCW-based CSI-RS;
measure the FMCW-based CSI-RS based on the FMCW-based CSI-RS configuration; and
transmit a CSI report message comprising a CSI report based on the measured FMCW-based CSI-RS and the FMCW-based ISAC CSI report configuration.

6. The apparatus of claim 5, wherein the FMCW-based CSI-RS configuration comprises a third indicator of a sampling rate and a fourth indicator of a sensing chirp length, wherein, to measure the FMCW-based CSI-RS, the at least one processor is configured to:
measure the FMCW-based CSI-RS based on the third indicator and the fourth indicator.

7. The apparatus of claim 5, wherein the FMCW-based CSI-RS configuration comprises a third indicator of a maximum sensing range, wherein, to measure the FMCW-based CSI-RS, the at least one processor is configured to:
measure the FMCW-based CSI-RS based on the third indicator.

8. The apparatus of claim 7, wherein, to measure the received reflection of the set of FMCW sensing signals based on the first indicator, the at least one processor is configured to measure the received reflection of the set of FMCW sensing signals further based on the third indicator, wherein, to process the set of FMCW communication signals based on the second indicator, the at least one processor is configured to process the set of FMCW communication signals further based on the third indicator.

9. The apparatus of claim 7, wherein, to measure the FMCW-based CSI-RS based on the third indicator, the at least one processor is configured to:
calculate a sensing chirp length based on the maximum sensing range; and
measure the FMCW-based CSI-RS based on the sensing chirp length, wherein the CSI report comprises a fourth indicator of the sensing chirp length.

10. The apparatus of claim 9, wherein, to measure the received reflection of the set of FMCW sensing signals based on the first indicator, the at least one processor is configured to measure the received reflection of the set of FMCW sensing signals further based on the sensing chirp length, wherein, to process the set of FMCW communication signals based on the second indicator, the at least one processor is configured to process the set of FMCW communication signals further based on the sensing chirp length.

11. The apparatus of claim 5, wherein the FMCW-based CSI-RS configuration comprises at least one of:
a third indicator of a configured shift offset;
a fourth indicator of a start frequency;
a fifth indicator of a bandwidth;
a sixth indicator of a time-domain position;
a seventh indicator of a CSI-RS chirp length; or
an eighth indicator of a periodicity.

12. The apparatus of claim 5, wherein the CSI report comprises a third indicator of a minimum inter-offset interval, wherein the set of FMCW sensing offsets are based on the third indicator; and the set of FMCW communication offsets are based on the third indicator.

13. The apparatus of claim 5, wherein the CSI report comprises at least one of:
a third indicator of a minimum inter-offset interval;
a channel quality indicator (CQI) associated with the measured FMCW-based CSI-RS; or
a fourth indicator of a signal-to-noise ratio (SNR) associated with the measured FMCW-based CSI-RS.

14. The apparatus of claim 1, wherein the FMCW sensing and communication configuration further comprises a third indicator of a chirp length, wherein, to measure the received reflection of the set of FMCW sensing signals based on the first indicator, the at least one processor is configured to measure the received reflection of the set of FMCW sensing signals further based on the third indicator, wherein, to process the set of FMCW communication signals based on the second indicator, the at least one processor is configured to process the set of FMCW communication signals further based on the third indicator.

15. The apparatus of claim 1, wherein the set of FMCW sensing signals and the set of FMCW communication signals share a same bandwidth and share a same duration.

16. The apparatus of claim 1, further comprising a transceiver coupled to the at least one processor, wherein the at least one processor is further configured to:
receive, via the transceiver, the transmission grant message; and
receive, via the transceiver, the reflection of the set of FMCW sensing signals.

17. An apparatus for wireless communication at a network node, comprising:
at least one memory; and
at least one processor coupled to the at least one memory and, based at least in part on information stored in the at least one memory, the at least one processor is configured to:
transmit a transmission grant message comprising a frequency-modulated continuous wave (FMCW) sensing and communication configuration including a first indicator of a set of FMCW sensing offsets, and a second indicator of a set of FMCW communication offsets; and
transmit a set of FMCW sensing signals based on a chirp length and the set of FMCW sensing offsets.

18. The apparatus of claim 17, wherein the at least one processor is further configured to:
transmit a set of FMCW communication signals based on the set of FMCW communication offsets.

19. The apparatus of claim 17, wherein the at least one processor is further configured to:
transmit at least one configuration message comprising an FMCW-based CSI-RS configuration and an FMCW-based integrated sensing and communication (ISAC) CSI report configuration;
transmit an FMCW-based CSI-RS based on the FMCW-based CSI-RS configuration; and
receive a CSI report message comprising a CSI report based on the transmitted FMCW-based CSI-RS and the FMCW-based ISAC CSI report configuration.

20. The apparatus of claim 19, wherein the at least one processor is further configured to:
calculate a sensing chirp length based on a sampling rate and a maximum sensing range, wherein the FMCW-based ISAC CSI report configuration comprises a third indicator of the sampling rate and a fourth indicator of the calculated sensing chirp length.

21-30. (canceled)
